(19) United States
(12) Patent Application Publication
(10) Pub. No.: US 2026/0346305 A1
(43) Pub. Date: Nov. 5, 2026

(54) GAS LINE CLEANING METHOD AND APPARATUS

(71) Applicant: Applied Materials, Inc., Santa Clara, CA (US)

(72) Inventors: Sasa Radivojevic, Austin, TX (US); Daemian Raj Benjamin Raj, Fremont, CA (US)

(21) Appl. No.: 19/455,715

(22) Filed: Jan. 21, 2026

Related U.S. Application Data
(60) Provisional application No. 63/799,247, filed on May 2, 2025.

(51) Int. Cl. B08B 9/032; B08B 7/02; F26B 21/00; F26B 21/40

(52) U.S. Cl. CPC B08B 9/0328; B08B 7/028; B08B 9/0325; F26B 21/006; F26B 21/40; B08B 2209/032

(57) ABSTRACT

A gas line cleaning method comprises cleaning operations. A submerged ultrasonic deionized (DI) water clean is performed on a gas line. A first purge operation is performed on the gas line by flowing DI water through the gas line. A second purge operation is performed on the gas line by flowing a mixture of the DI water and an inert gas through the gas line. A drying operation is performed by flowing the inert gas through the gas line.

### RELATED

This application claims the benefit of U.S. Provisional Patent Application No. 63/799,247 filed May 2, 2025, entitled "Gas Line Cleaning Method and Apparatus" which is incorporated by reference herein.

### TECHNICAL FIELD

Embodiments of the present disclosure relate to a method and apparatus for cleaning gas lines. In particular, the present disclosure describes a method and apparatus for cleaning gas lines used in substrate processing systems.

### BACKGROUND

In substrate processing and other electronics processing, various process gases are delivered into chambers through dedicated gas lines. These gases support operations such as etching, deposition, and cleaning. Gas line manufacturing for semiconductor applications involves precision assembly and welding of tubing (e.g., stainless-steel tubing), valves, and manifolds to form a leak-tight, ultra-clean distribution network. Welds—often performed using orbital welding techniques—are executed to ensure uniform, contamination-free joints that meet stringent cleanliness and integrity standards.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a gas line cleaning method comprises performing a submerged ultrasonic deionized (DI) water clean on a gas line, performing a first purge operation on the gas line by flowing DI water through the gas line, performing a second purge operation on the gas line by flowing a mixture of the DI water and an inert gas through the gas line, and performing a drying operation by flowing the inert gas through the gas line.

In an aspect of the disclosure, a gas line cleaning apparatus comprises a first fluid line of a plurality of fluid lines, wherein the first fluid line is configured to provide hot DI water; a second fluid line of the plurality of fluid lines, wherein the second fluid line is configured to provide cold DI water, and wherein the second fluid line is coupled to the first fluid line and a third fluid line; and the third fluid line of the plurality of fluid lines, wherein the third fluid line is configured to provide an inert gas to a gas line, and wherein the third fluid line is coupled to the first fluid line and the second fluid line. In some embodiments, the plurality of fluid lines comprises one or more functional fixtures placed along the fluid lines.

In an aspect of the disclosure, a gas line cleaning method comprises performing a first purge operation on a gas line by flowing deionized (DI) water through a gas line while performing ultrasonic agitation on the gas line, performing a second purge operation on the gas line by flowing a mixture of the DI water and an inert gas through the gas line, and performing a drying operation by flowing the inert gas through the gas line.

In an aspect of the disclosure, a gas line cleaning apparatus comprises: a first fluid line of a plurality of fluid lines, configured to provide hot DI water to a gas line, wherein an ultrasonic agitation mechanism is affixed to the gas line; a second fluid line configured to provide cold DI water to the gas line, and wherein the second fluid line is coupled to the first fluid line and a third fluid line; and the third fluid line, wherein the third fluid line is configured to provide an inert gas to the gas line, and wherein the third fluid line is coupled to the first fluid line and the second fluid line; wherein the gas cleaning apparatus is configured to: perform a first purge operation on the gas line by flowing the cold DI water through the gas line while performing ultrasonic agitation on the gas line; perform a second purge operation on the gas line by flowing a mixture of the hot DI water and the inert gas through the gas line; perform a third purge operation on the gas line by flowing the cold DI water through the gas line; and perform a drying operation by flowing the inert gas through the gas line.

In an aspect of the disclosure, an ultrasonic agitation mechanism comprises: a first plate, wherein the first plate comprises a first channel formed on an inner surface of the first plate, the first channel being configured to receive a first side of a gas line; a second plate, wherein the second plate comprises a second channel formed on an inner surface of the second plate, the second channel being configured to receive a second side of the gas line, and wherein the first plate and the second plate are affixed to each other using a mechanical fastener or compression fixture to clamp the gas line between the first plate and the second plate; and an ultrasonic transducer affixed to the first plate and configured to generate ultrasonic vibrations that are transmitted through the first plate to the gas line.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1A illustrates a diagram of a gas line cleaning apparatus, in accordance with some embodiments of the present disclosure.

FIG. 1B illustrates a diagram of a gas line cleaning apparatus, in accordance with some embodiments of the present disclosure.

FIG. 2 is a flow diagram of an example method of a gas line cleaning method, in accordance with some embodiments of the present disclosure.

FIG. 3 is a flow diagram of an example method of a gas line cleaning method, in accordance with some embodiments of the present disclosure.

FIG. 4A illustrates an ultrasonic agitation mechanism from a first side schematic view, in accordance with some embodiments of the present disclosure.

FIG. 4B illustrates an ultrasonic agitation mechanism from a second side schematic view, in accordance with some embodiments of the present disclosure.

### DETAILED DESCRIPTION OF EMBODIMENTS

Embodiments described herein are related to a gas line cleaning method and apparatus.

In semiconductor manufacturing, high-purity process gases are delivered to reaction chambers through complex gas-line networks composed of stainless-steel tubing, valves, and manifolds. These gas delivery systems must meet stringent cleanliness standards, as even trace levels of particulate contamination can compromise device performance and reduce yield. Conventional gas-line fabrication involves precision welding techniques, such as orbital welding, to ensure leak-tight and uniform joints.

During fabrication, microscopic metal particles from the weldments can remain adhered to internal surfaces of gas lines. Such “gas lines” encompass not only pipes and conduits but also any component in the gas-delivery network through which process fluids pass—for example, flow-control devices (e.g., mass flow controllers, laminar flow meters, etc.), filters, valves, manifolds, and other inline fixtures. These components all present internal surfaces where particulates may accumulate and later dislodge during operation. Particles left over from weld seams can become dislodged during normal high‐flow operations, entering a process chamber connected to the gas lines, and depositing on substrates. Such contamination degrades device performance, increases defect rates, and reduces overall yield.

Aspects of the present disclosure address the above and other deficiencies by employing methods for gas line cleaning. The methods include cleaning operations such as purge sequences, with varying durations, mixtures, and temperatures.

In one such cleaning operation, a purge operation pushes a mixture of DI water and an inert gas through a fabricated gas line to clean the interior of the gas line. In some embodiments, this ratio between the DI water and the inert gas is determined based on characteristics of the gas line. Characteristics can include the internal geometry of the gas line and the associated contamination profile. In some implementations, the inert gas used is nitrogen and the gas is of an ultra high purity (UHP) rating, meaning it contains less than 1 part per million (ppm) of total impurities, including moisture, oxygen, hydrocarbons, and other trace contaminants. The inert gas and DI water mix within a delivery line connected to the gas line and create a turbulent flow of gas and water that dislodges any residual particles (e.g., metallic particles) on the interior of the gas line being cleaned.

In another cleaning operation, ultrasonic agitation is applied to the gas line during a DI water purge. An ultrasonic agitation mechanism—comprising a pair of clamping plates with embedded or attached ultrasonic transducers—is affixed around the gas line. The transducers transmit ultrasonic vibrations through the gas line wall, loosening particles adhered to the interior surface of the gas line. The DI water flowing through the gas line flushes out the dislodged particles (e.g., during the ultrasonic agitation).

These methods can be implemented using an apparatus designed to facilitate gas line cleaning. The apparatus includes multiple fluid lines, each delivering a fluid to the gas line to clean it. In an example implementation of the apparatus, fluid lines provide hot DI water, cold DI water, and the inert gas to the gas line to be cleaned. The fluid lines are coupled together to facilitate cleaning operations such as mixing DI water and an inert gas (such as nitrogen). Functional fixtures situated along the fluid lines allow for control over the cleaning process. For example, heating elements and thermal sensors can be integrated into the apparatus to maintain temperature accuracy (e.g., for the DI water and/or the inert gas) throughout the cleaning cycle.

Advantages of the present disclosure include, but are not limited to, reduced contamination levels within manufacturing systems and, consequently, improved product (e.g., substrate wafers) yield. By utilizing optimized purge cycles, precise flow control, and compatible cleaning agents, sub-micron particles can be effectively removed from internal surfaces of fabricated gas lines. As a result, particle counts at the wafer surface may be lowered, improving both yield and reliability in semiconductor production. The process ensures superior system cleanliness and long-term performance in critical environments such as cleanrooms.

Although some embodiments of the present disclosure are described with relation to gas lines, in some embodiments, the present disclosure may be used for cleaning other like components of fluid distribution systems which present internal surfaces where particulates may accumulate and later dislodge during operation. For example, mass flow controllers, laminar flow meters, filters, valves, manifolds, and other inline fixtures.

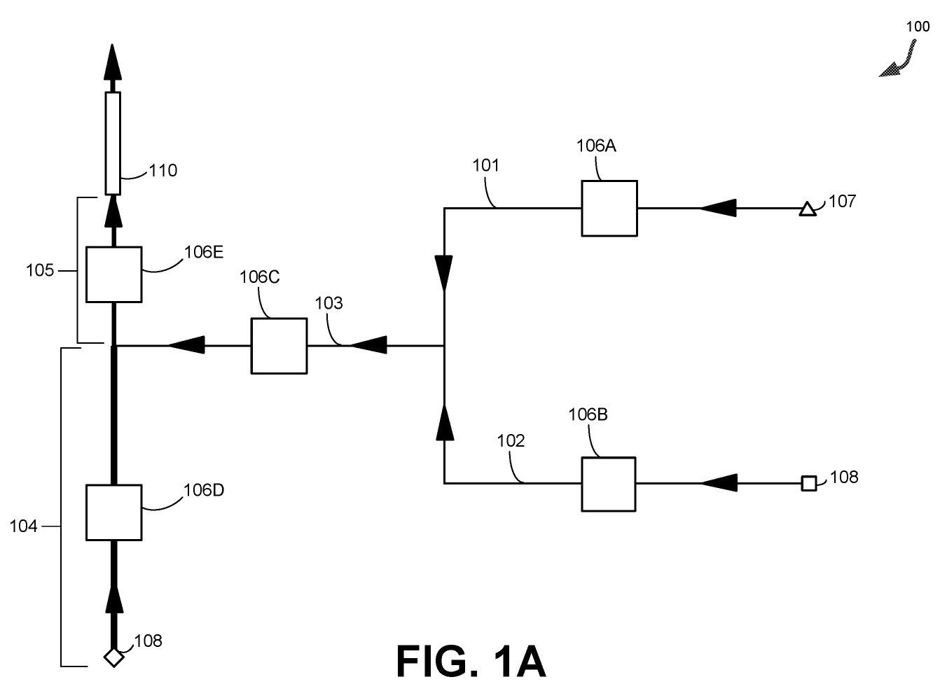

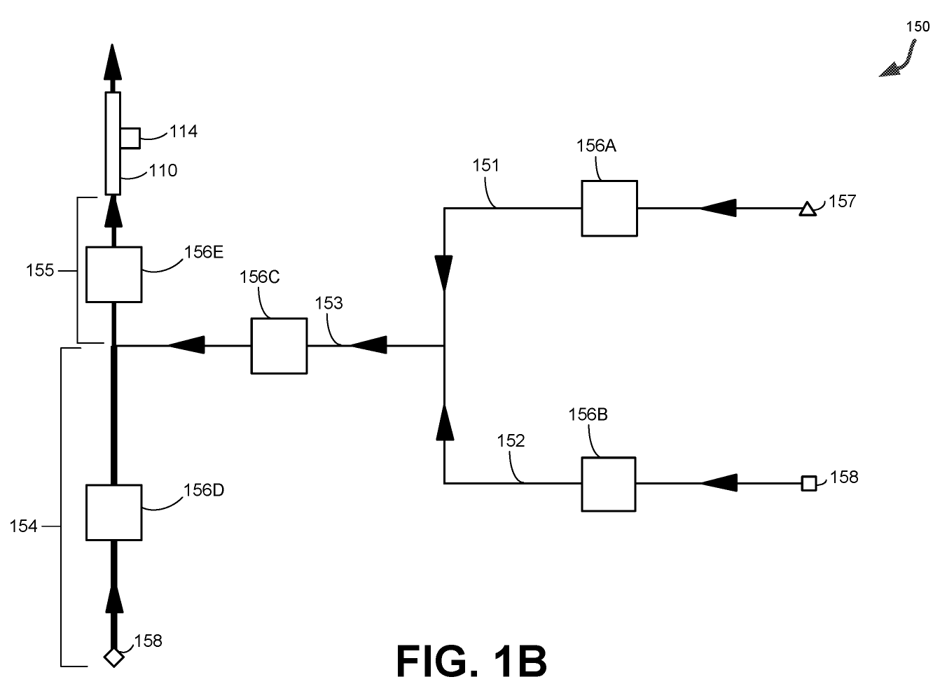

FIG. 1A illustrates a diagram of an example gas line cleaning apparatus 100, in accordance with some embodiments of the present disclosure. It should be understood that the orientation of the fluid lines within the apparatus is not limited to the configuration illustrated in FIG. 1A. The effectiveness of the cleaning apparatus and its use described herein is maintained regardless of the fluid lines’ spatial orientation.

The apparatus 100 comprises a plurality of fluid lines: a fluid line 101, a fluid line 102, a shared fluid line 103 (e.g., shared between fluid lines 101 and 102), a fluid line 104, and a delivery fluid line 105. Directional arrows are added to describe the direction of the fluid in the fluid lines 101-105. In some embodiments, the fluid lines comprise one or more functional fixtures (e.g., functional fixtures 106A-E). Functional fixtures can include: a manual valve, a regulator, a transducer, a filter, a pneumatic valve, an injection valve, a check valve, a flow restrictor, a port pneumatic valve, a hybrid valve, a mass flow controller (MFC), a port block valve, a flow-through cap, a resistivity meter, a reservoir, or a fluid heater.

In some embodiments, one or more of the fluid lines vary in diameter relative to the other fluid lines. Varying diameter combinations of fluid lines allow for localized pressure adjustments within the fluid lines as required by the gas-line cleaning process. For example, across fluid line 104 and delivery fluid line 105, a transition from ½ to ¼ internal diameter increases fluid velocity and pressure at the smaller section, enhancing shear forces to dislodge particles, while the upstream larger diameter maintains overall flow stability and reduces back-pressure. Suitable diameter combinations include, but are not limited to, a ⅜ inch fluid line transitioning into a ¼ inch fluid line or a ½ inch fluid line transitioning into a ¼ inch fluid line.

In the example apparatus 100, fluid line 101 includes functional fixture 106A and is coupled to a DI water source 106, and is configured to deliver hot (e.g., a temperature above 100°F) DI water to gas line 110. In an example, functional fixture 106A can be a fluid heater component integrated into fluid line 101 to precisely control the temperature of the DI water flowing into delivery fluid line 105 and subsequently into gas line 110. In embodiments, the diameter of fluid line 101 can range from ¼ inch to 1 inch, including specific sizes such as ¼ inch, ⅜ inch, ½ inch, and ¾ inch, to accommodate varying flow and pressure requirements.

Fluid line 102 includes a functional fixture 106B and is coupled to a DI water source 107, and is configured to provide cold (e.g., a temperature equal to or below 100°F) DI water to the gas line 110. In the example apparatus 100, the fluid line 102 is coupled with fluid line 101 to flow into a shared fluid line 103 into a fluid line 104. Some embodiments have the fluid lines 101 and 102 flowing into the delivery fluid line 105 (and into the gas line) without the need for the shared fluid line 103. In embodiments, the diameter of fluid line 102 can range from ¼ inch to 1 inch, including specific sizes such as ¼ inch, ⅜ inch, ½ inch, and ¾ inch, to accommodate varying flow and pressure requirements.

Fluid line 103 includes a functional fixture 106C and bridges fluid lines 101 and 102 with fluid line 104. In an example, functional fixture 106C can be a reservoir, allowing for a steady flow of DI water (e.g., supplementing any interruption of the DI water flow from fluid lines 101 and 102) into fluid line 104 and subsequently into gas line 110. The reservoir is maintained at the same supply pressure as the upstream DI water fluid lines (e.g., fluid lines 101 and 102), so that any sudden pressure drop or flow interruption in the fluid lines is immediately compensated by water released from the reservoir. As a result, fluid line 105—and thus gas line 110—experiences a steady, uninterrupted, pressure-driven flow throughout the cleaning cycle. In embodiments, the diameter of fluid line 103 can range from ¼ inch to 1 inch, including specific sizes such as ¼ inch, ⅜ inch, ½ inch, and ¾ inch, to accommodate varying flow and pressure requirements.

Fluid line 104 includes a functional fixture 106D and is coupled to an inert gas source 109 and the gas line 110. The fluid line 104 is configured to provide the inert gas to delivery fluid line 105 and thus the gas line 110. In an example, functional fixture 106D can be a fluid heater component integrated into fluid line 104 to precisely control the temperature of the inert gas flowing into gas line 110. In embodiments, the diameter of fluid line 104 can range from ¼ inch to 1 inch, including specific sizes such as ¼ inch, ⅜ inch, ½ inch, and ¾ inch, to accommodate varying flow and pressure requirements.

Fluid line 105 includes a functional fixture 106E and is coupled to the fluid line 104 and the gas line 110. As shown in FIG. 1, the fluid line 105 is configured to provide fluids to the gas line 110. In embodiments, the diameter of fluid line 105 can range from ¼ inch to 1 inch, including specific sizes such as ¼ inch, ⅜ inch, ½ inch, and ¾ inch, to accommodate varying flow and pressure requirements.

In some embodiments, the fluid lines 101-105 are fabricated from high-purity, corrosion-resistant materials compatible with deionized (DI) water, inert gases, temperatures exceeding 100°F, and pressures in excess of 30 pounds per square inch (psi). For example, in rigid sections, nickel-plated brass or passivated aluminum can be used for the fluid lines and the material of fasteners and fixtures (e.g., functional fixtures 106A-E). Flexible or movable segments can employ polytetrafluoroethylene (PTFE)-lined hose or perfluoroalkoxy (PFA) polymer tubing to combine chemical inertness with enhanced routing flexibility. The apparatus is not limited to the specific materials described herein. Other materials can be used for the fluid lines and components, provided they are compatible with the chemical, thermal, and cleanliness requirements of the gas-line cleaning process.

Fluid lines and fixtures can be coupled with fittings such as vacuum coupling radiation (VCR), threaded, weld-on (including orbital welding), or quick-disconnect types. Seals can include O-rings, metal gaskets, and brazing. Other coupling methods can be used for the fluid lines and components, provided they are compatible with the chemical, thermal, and cleanliness requirements of the gas-line cleaning process.

FIG. 1B illustrates a diagram of an example gas line cleaning apparatus 150, in accordance with some embodiments of the present disclosure. It should be understood that the orientation of the fluid lines within the apparatus is not limited to the configuration illustrated in FIG. 1B. The effectiveness of the cleaning apparatus and its use described herein is maintained regardless of the fluid lines’ spatial orientation.

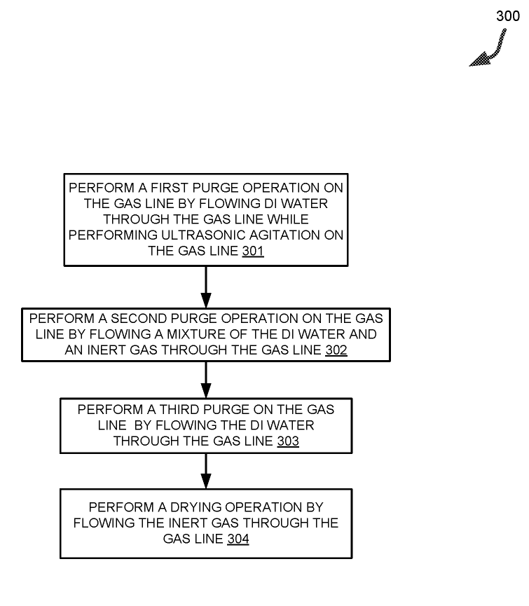

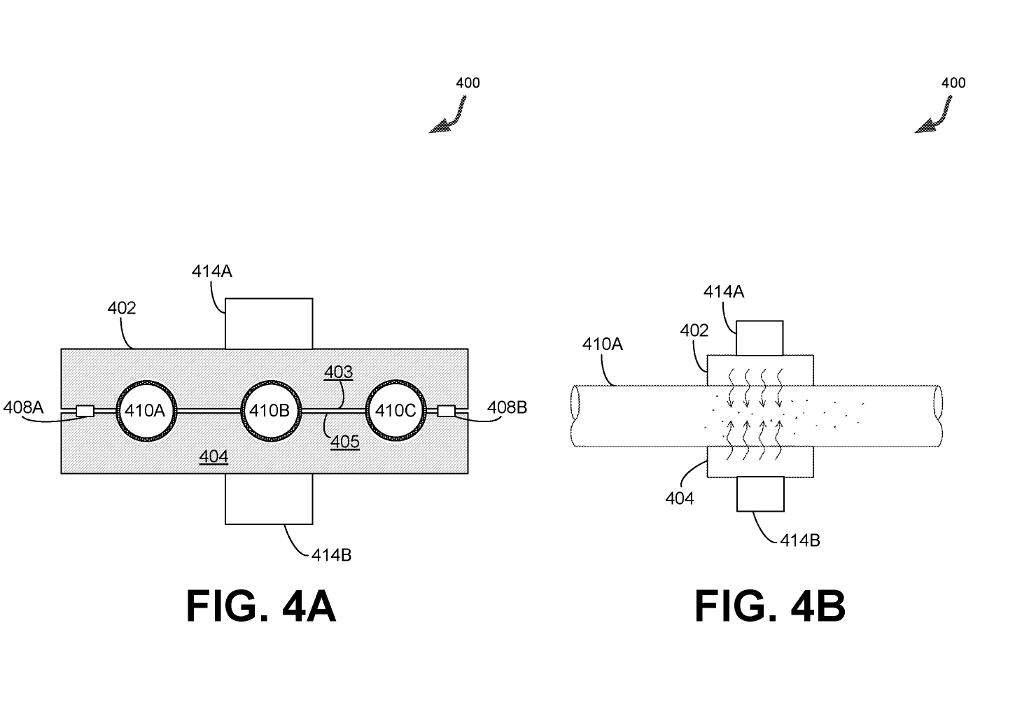

The apparatus 150 comprises a plurality of fluid lines: a fluid line 151, a fluid line 152, a shared fluid line 153 (e.g., shared between fluid lines 151 and 152), a fluid line 154, and a delivery fluid line 155. Directional arrows are added to describe the direction of the fluid in the fluid lines 151-155. In some embodiments, the fluid lines comprise one or more functional fixtures (e.g., functional fixtures 156A-E). Functional fixtures can include: a manual valve, a regulator, a transducer, a filter, a pneumatic valve, an injection valve, a check valve, a flow restrictor, a port pneumatic valve, a hybrid valve, a mass flow controller (MFC), a port block valve, a flow-through cap, a resistivity meter, a reservoir, or a fluid heater. In some embodiments, an ultrasonic agitation mechanism 114 is affixed to the gas line 110. Further details on the ultrasonic agitation mechanism are provided in FIGS. 3, 4A and 4B.

In some embodiments, one or more of the fluid lines vary in diameter relative to the other fluid lines. Varying diameter combinations of fluid lines allow for localized pressure adjustments within the fluid lines as required by the gas-line cleaning process. For example, across fluid line 154 and delivery fluid line 155, a transition from ½ to ¼ internal diameter increases fluid velocity and pressure at the smaller section, enhancing shear forces to dislodge particles, while the upstream larger diameter maintains overall flow stability and reduces back-pressure. Suitable diameter combinations include, but are not limited to, a ⅜ inch fluid line transitioning into a ¼ inch fluid line or a ½ inch fluid line transitioning into a ¼ inch fluid line.

In the example apparatus 150, fluid line 151 includes functional fixture 156A and is coupled to a DI water source 156, and is configured to deliver hot (e.g., a temperature above 100°F) DI water to gas line 110. In an example, functional fixture 156A can be a fluid heater component integrated into fluid line 151 to precisely control the temperature of the DI water flowing into delivery fluid line 155 and subsequently into gas line 110. In embodiments, the diameter of fluid line 151 can range from ¼ inch to 1 inch, including specific sizes such as ¼ inch, ⅜ inch, ½ inch, and ¾ inch, to accommodate varying flow and pressure requirements.

Fluid line 152 includes a functional fixture 156B and is coupled to a DI water source 157, and is configured to provide cold (e.g., a temperature equal to or below 100°F) DI water to the gas line 110. In the example apparatus 150, the fluid line 152 is coupled with fluid line 151 to flow into a shared fluid line 153 into a fluid line 154. Some embodiments have the fluid lines 151 and 152 flowing into the delivery fluid line 155 (and into the gas line) without the need for the shared fluid line 153. In embodiments, the diameter of fluid line 152 can range from ¼ inch to 1 inch, including specific sizes such as ¼ inch, ⅜ inch, ½ inch, and ¾ inch, to accommodate varying flow and pressure requirements.

Fluid line 153 includes a functional fixture 156C and bridges fluid lines 151 and 152 with fluid line 154. In an example, functional fixture 156C can be a reservoir, allowing for a steady flow of DI water (e.g., supplementing any interruption of the DI water flow from fluid lines 151 and 152) into fluid line 154 and subsequently into gas line 110. The reservoir is maintained at the same supply pressure as the upstream DI water fluid lines (e.g., fluid lines 151 and 152), so that any sudden pressure drop or flow interruption in the fluid lines is immediately compensated by water released from the reservoir. As a result, fluid line 155—and thus gas line 110—experiences a steady, uninterrupted, pressure-driven flow throughout the cleaning cycle. In embodiments, the diameter of fluid line 153 can range from ¼ inch to 1 inch, including specific sizes such as ¼ inch, ⅜ inch, ½ inch, and ¾ inch, to accommodate varying flow and pressure requirements.

Fluid line 154 includes a functional fixture 156D and is coupled to an inert gas source 159 and the gas line 110. The fluid line 154 is configured to provide the inert gas to delivery fluid line 155 and thus the gas line 110. In an example, functional fixture 156D can be a fluid heater component integrated into fluid line 154 to precisely control the temperature of the inert gas flowing into gas line 110. In embodiments, the diameter of fluid line 154 can range from ¼ inch to 1 inch, including specific sizes such as ¼ inch, ⅜ inch, ½ inch, and ¾ inch, to accommodate varying flow and pressure requirements.

Fluid line 155 includes a functional fixture 156E and is coupled to the fluid line 154 and the gas line 110. As shown in FIG. 1 , the fluid line 155 is configured to provide fluids to the gas line 110. In embodiments, the diameter of fluid line 155 can range from ¼ inch to 1 inch, including specific sizes such as ¼ inch, ⅜ inch, ½ inch, and ¾ inch, to accommodate varying flow and pressure requirements.

In some embodiments, the fluid lines 151-155 are fabricated from high-purity, corrosion-resistant materials compatible with deionized (DI) water, inert gases, temperatures exceeding 100°F, and pressures in excess of 30 pounds per square inch (psi). For example, in rigid sections, nickel-plated brass or passivated aluminum can be used for the fluid lines and the material of fasteners and fixtures (e.g., functional fixtures 156A-E). Flexible or movable segments can employ polytetrafluoroethylene (PTFE)-lined stainless-steel hose or perfluoroalkoxy (PFA) polymer tubing to combine chemical inertness with enhanced routing flexibility. The apparatus is not limited to the specific materials described herein. Other materials can be used for the fluid lines and components, provided they are compatible with the chemical, thermal, and cleanliness requirements of the gas-line cleaning process.

Fluid lines and fixtures can be coupled with fittings such as vacuum coupling radiation (VCR), threaded, weld-on (including orbital welding), or quick-disconnect types. Seals can include O-rings, metal gaskets, and brazing. Other coupling methods can be used for the fluid lines and components, provided they are compatible with the chemical, thermal, and cleanliness requirements of the gas-line cleaning process.

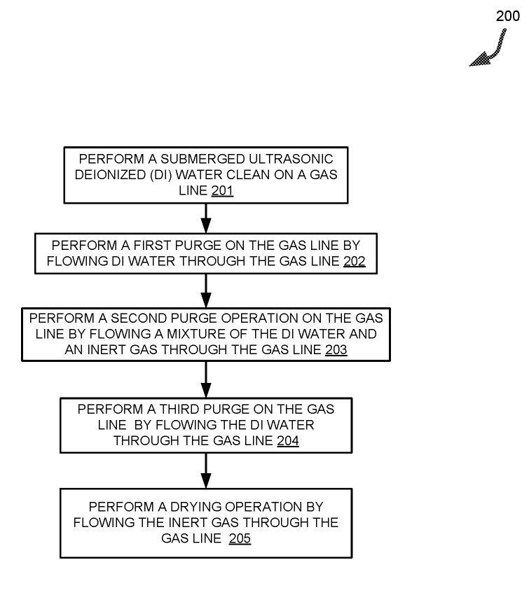

FIG. 2 is a flow diagram of an example method 200 of a gas line cleaning method, in accordance with some embodiments of the present disclosure. In particular, FIG. 2 can be carried out by the gas line cleaning apparatus 100 of FIG. 1A. The method 200 can be carried out automatically or manually, using electronic or mechanical controls. In some embodiments, the method 200 can be performed by dedicated hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 201, a submerged ultrasonic DI water clean is performed on the gas line. In some embodiments, performing a submerged ultrasonic DI water clean on the gas line 110 involves immersing the gas line into an ultrasonic cleaning bath filled with DI water. In the ultrasonic cleaning bath, ultrasonic transducers generate high-frequency acoustic cavitation bubbles that collapse violently near internal surfaces, dislodging particles—including welds , metal fines, and sub-micron debris (e.g., debris from the internal surface of the gas line). In an example embodiment, the DI water bath is operated between 145–175 °F for 3–5 minutes. In some embodiments, the DI water used during the purge operation has a resistivity of 4 or greater megaohm-centimeters.

At operation 202, a first purge operation is performed on the gas line 110 by flowing DI water through the gas line. In an example embodiment using the gas cleaning apparatus 100 of FIG. 1A, DI water flows from the DI water source 106 through fluid line 101 (or from DI water source 107 through fluid line 102), passes through any installed functional fixtures (e.g., fluid heaters, filters, or flow restrictors), continues through the shared fluid line 103 and fluid line 104 (through any installed functional fixtures), and ultimately enters and flows through gas line 110, flushing out debris from its interior surfaces. In an example embodiment, the DI water purge is conducted at 60–80 °F for 2–4 minutes. In some embodiments, the DI water used during the purge operation has a resistivity of 16 or greater megaohm-centimeters, indicating ultra-high purity suitable for dissolving nano-scale particles from the interior surfaces of the gas line.

At operation 203, a second purge operation is performed on the gas line 110 by flowing a mixture of DI water and an inert gas through the gas line. In an example embodiment using the gas cleaning apparatus 100 of FIG. 1A , DI water flows from the DI water source 106 through fluid line 101 (or from DI water source 107 through fluid line 102), passes through any installed functional fixtures (ex., fluid heaters, filters, or flow restrictors), continues through shared fluid line 103 and into fluid line 104 (through any installed functional fixtures). An inert gas (flowing from an inert gas source 109) flows through fluid line 104 (through any installed functional fixtures 106D (ex., fluid heaters, filters, or flow restrictors)) and meets the DI water where the shared fluid line 103 and fluid line 104 meet, creating a mixture which ultimately enters and flows through gas line 110, flushing out debris from its interior surfaces. In an example embodiment, prior to mixing, the DI water and the inert gas are at 115–145 °F and 110-130 °F, respectively. The DI water is supplied at 40 psi or higher, co-flowing with the inert gas at 80 psi or higher, for 5–8 minutes. In some embodiments, the DI water used during the purge operation has a resistivity of 16 or greater megaohm-centimeters.

In some embodiments, the inert gas is nitrogen. In some embodiments, the ratio in the mixed second purge operation is inherently determined by the hydraulic characteristics of the two supplying fluid lines—specifically, their internal diameters and inlet pressure. In some embodiments, the characteristics of the gas line include an internal geometry of the gas line (ex. diameter variations, bends, or manifold complexity) and a contamination profile associated with the gas line (e.g., concentration of residues detected by functional fixtures during prior cleaning steps). For example, for lines with a larger diameter, the flow velocity of both water and gas decreases at a given pressure, reducing shear forces on the interior wall of the gas line. To compensate, the system increases the DI water fraction in the mixed purge to restore sufficient shear and flushing action. Conversely, for smaller-diameter or highly convoluted sections, the apparatus raises the inert-gas fraction in the blend to boost turbulence and cavitation, enhancing particle removal.

In some embodiments, at operation 204, a third purge operation is performed on the gas line by flowing the DI water through the gas line prior to performing a drying operation described below. In some embodiments, the third purge operation is performed after performing the second purge operation. In an example embodiment using the gas cleaning apparatus 100 of FIG. 1A, DI water flows from the DI water source 106 through fluid line 101 (or from DI water source 107 through fluid line 102), passes through any installed functional fixtures (ex., fluid heaters, filters, or flow restrictors), continues through shared fluid line 103 and fluid line 104 (through any installed functional fixtures), and ultimately enters and flows through gas line 110, flushing out debris from its interior surfaces. In some embodiments, the DI water used in the third purge operation has a temperature less than or equal to 100°F. In an example embodiment, the third DI water purge is run at 60–80 °F and 40 psi or higher for 2–4 minutes. In some embodiments, the DI water used during the purge operation has a resistivity of 16 or greater megaohm-centimeters.

At operation 205, a drying operation is performed on the gas line 110 by flowing the inert gas through the gas line. In some embodiments, the inert gas used is the same as that used in operation 203. In some embodiments, the inert gas used is different from that used in operation 203. In some embodiments, the inert gas is heated (e.g., by a functional fixture 106D in FIG. 1A). In some embodiments, the inert gas has a temperature greater than 100° F. In an example embodiment, the inert-gas dry step is carried out at 110–140° F and 80 psi or higher for 2–4 minutes.

During the cleaning operations described in operations 201-205, the temperature of the fluids and the duration of the cleaning operations can vary. In some embodiments, the operations are each performed for pre-determined durations. In some embodiments, the DI water used in a purge operation has a temperature greater than 100° F. In some embodiments, the DI water used for at least one of the first purge operation or the second purge operation has a temperature less than or equal to 100° F. In some embodiments, the inert gas has a temperature greater than 100° F. In some embodiments, the DI water used in the submerged ultrasonic DI water clean operation has a temperature greater than 100° F.

Transitioning between low and high purge temperatures enhances contaminant removal by combining thermal and fluid‐mechanical effects. During cold purges (60–80 °F), higher water viscosity improves wetting and mobilizes loosely bound particulates without disturbing sensitive residues. Hot purges (115–145 °F) reduce viscosity, increase cavitation, and amplify shear forces to deep‐clean stubborn, weld-related debris. The resulting thermal gradient also induces differential expansion or softening of residual films, aiding in their dislodgement.

FIG. 3 is a flow diagram of an example method 300 of a gas line cleaning method, in accordance with some embodiments of the present disclosure. In particular, FIG. 3 can be carried out by the gas line cleaning apparatus 150 of FIG. 1B. The method 300 can be carried out automatically or manually, using electronic or mechanical controls. In some embodiments, the method 300 can be performed by dedicated hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 301, a first purge operation is performed on the gas line 110 by flowing DI water through the gas line while performing ultrasonic agitation on the gas line. In an example embodiment using the gas cleaning apparatus 150 of FIG. 1B , DI water flows from the DI water source 156 through fluid line 151 (or from DI water source 157 through fluid line 152), passes through any installed functional fixtures (e.g., fluid heaters, filters, or flow restrictors), continues through the shared fluid line 153 and fluid line 154 (through any installed functional fixtures), and ultimately enters and flows through gas line 110, flushing out debris from its interior surfaces. In an example embodiment, the DI water purge is conducted at 60–80 °F for 2–4 minutes. In some embodiments, the DI water used during the purge operation has a resistivity of 16 or greater megaohm-centimeters, indicating ultra-high purity suitable for dissolving nano-scale particles from the interior surfaces of the gas line.

The ultrasonic agitation is performed by the ultrasonic agitation mechanism while the DI water is flowed through the gas line. In some embodiments, the ultrasonic agitation mechanism comprises a pair of plates affixed around the gas line 110, with at least one plate having one or more ultrasonic transducers configured to transmit vibrations through the wall of the gas line. These vibrations loosen particles adhered to the interior surfaces of the gas line, including nano-scale contaminants that may not be dislodged by fluid flow alone. Vibrations transmitted through the plates agitate the gas line walls, loosening particles and contaminants, which are concurrently or subsequently flushed out by a DI water purge flowing through the interior of the gas line 110. In some embodiments, the transducers operate at frequencies between 20 kHz and 80 kHz. For example, in an embodiment, the transducers operate at 40 kHz. The plates may be formed from materials such as aluminum, stainless steel, or ceramic, selected for their acoustic transmission properties and mechanical compatibility with the gas line. In some embodiments, the material in contact with the gas line has a mechanical hardness less than that of the gas line to prevent damage during clamping. Further details are provided in FIGS. 4A and 4B.

At operation 302, a second purge operation is performed on the gas line 110 by flowing a mixture of DI water and an inert gas through the gas line. In an example embodiment using the gas cleaning apparatus 150 of FIG. 1B , DI water flows from the DI water source 156 through fluid line 151 (or from DI water source 157 through fluid line 152), passes through any installed functional fixtures (ex., fluid heaters, filters, or flow restrictors), continues through shared fluid line 153 and into fluid line 154 (through any installed functional fixtures). An inert gas (flowing from an inert gas source 159) flows through fluid line 154 (through any installed functional fixtures 156D (ex., fluid heaters, filters, or flow restrictors)) and meets the DI water where the shared fluid line 153 and fluid line 154 meet, creating a mixture which ultimately enters and flows through gas line 110, flushing out debris from its interior surfaces. In an example embodiment, prior to mixing, the DI water and the inert gas are at 115–145 °F and 110-130 °F, respectively. The DI water is supplied at 40 psi or higher, co-flowing with the inert gas at 80 psi or higher, for 5–8 minutes. In some embodiments, the DI water used during the purge operation has a resistivity of 16 or greater megaohm-centimeters.

In some embodiments, the inert gas is nitrogen. In some embodiments, the ratio between the DI water and the inert gas of the second purge is determined according to a characteristic of the gas line. In some embodiments, the ratio in the mixed second purge operation is inherently determined by the hydraulic characteristics of the two supplying fluid lines—specifically, their internal diameters and inlet pressure. In some embodiments, the characteristics of the gas line include an internal geometry of the gas line (ex. diameter variations, bends, or manifold complexity) and a contamination profile associated with the gas line (e.g., concentration of residues detected by functional fixtures during prior cleaning steps). For example, for lines with a larger diameter, the flow velocity of both water and gas decreases at a given pressure, reducing shear forces on the interior wall of the gas line. To compensate, the system increases the DI water fraction in the mixed purge to restore sufficient shear and flushing action. Conversely, for smaller-diameter or highly convoluted sections, the apparatus raises the inert-gas fraction in the blend to boost turbulence and cavitation, enhancing particle removal.

In some embodiments, at operation 303, a third purge operation is performed on the gas line by flowing the DI water through the gas line prior to performing a drying operation described below. In some embodiments, the third purge operation is performed responsive to or after performing the second purge operation. In an example embodiment using the gas cleaning apparatus 150 of FIG. 1B , DI water flows from the DI water source 156 through fluid line 151 (or from DI water source 157 through fluid line 152), passes through any installed functional fixtures (ex., fluid heaters, filters, or flow restrictors), continues through shared fluid line 153 and fluid line 154 (through any installed functional fixtures), and ultimately enters and flows through gas line 110, flushing out debris from its interior surfaces. In some embodiments, the DI water used in the third purge operation has a temperature less than or equal to 100°F. In an example embodiment, the third DI water purge is run at 60–80 °F and 40 psi or higher for 2–4 minutes. In some embodiments, the DI water used during the purge operation has a resistivity of 16 or greater megaohm-centimeters.

At operation 304, a drying operation is performed on the gas line 110 by flowing the inert gas through the gas line. In some embodiments, the inert gas used is the same as that used in operation 303. In some embodiments, the inert gas used is different from that used in operation 303. In some embodiments, the inert gas is heated (e.g., by a functional fixture 156D in FIG. 1B). In some embodiments, the inert gas has a temperature greater than 100°F. In an example embodiment, the inert-gas dry step is carried out at 110–140 °F and 80 psi or higher for 2–4 minutes.

During the cleaning operations described in operations 301-304, the temperature of the fluids and the duration of the cleaning operations can vary. In some embodiments, the operations are each performed for pre-determined durations. In some embodiments, the DI water used in a purge operation has a temperature greater than 100°F. In some embodiments, the DI water used for at least one of the first purge operation or the second purge operation has a temperature less than or equal to 100°F. In some embodiments, the inert gas has a temperature greater than 100°F. In some embodiments, the DI water used in the submerged ultrasonic DI water clean operation has a temperature greater than 100°F.

Transitioning between low and high purge temperatures enhances contaminant removal by combining thermal and fluid‐mechanical effects. During cold purges (60–80 °F), higher water viscosity improves wetting and mobilizes loosely bound particulates without disturbing sensitive residues. Hot purges (115–145 °F) reduce viscosity, increase cavitation, and amplify shear forces to deep‐clean stubborn, weld-related debris. The resulting thermal gradient also induces differential expansion or softening of residual films, aiding in their dislodgement.

FIGS. 4A and 4B illustrate an ultrasonic agitation mechanism 400, in accordance with embodiments of the present disclosure.

FIG. 4A illustrates an ultrasonic agitation mechanism 400 from a first side schematic view, in accordance with embodiments of the present disclosure. The apparatus comprises a first plate 402 and a second plate 404, each plate having an inner surface 403 and 405, respectively, with one or more channels. Each channel is configured to receive a gas line. The channels are dimensioned to securely hold (e.g., clamp) the gas line in place between the first plate 402 and the second plate 404 when the plates are affixed together using mechanical fasteners 408A and 408B or a compression fixture. In embodiments, the channels are gas line-shaped and set in the plates 402 and 404. Different sets of plates may be used for differently sized gas lines. Accordingly, the size and shape of the channels in the plates may match the outer walls of the gas lines. This may ensure an optimal connection between the gas line and the ultrasonic agitation mechanism 400 to enable ultrasonic agitation of the gas lines. Alternative embodiments can use other appropriate means of fastening the plates together (with the gas line clamped between the plates). In this embodiment, gas lines 410A, 410B, and 410C are shown positioned within the channels of both plates. In some embodiments, the first plate and the second plate each comprise a plurality of channels, with channel pairs (e.g., channels in the first plate and second plate that align) each configured to receive a separate gas line, such that multiple gas lines can be cleaned in parallel.

Affixed to the first plate 402 and, in some embodiments, the second plate 404 are ultrasonic transducers 414A and 414B, respectively. The ultrasonic transducers are configured to generate ultrasonic vibrations that are transmitted through the plate they are affixed to and into the one or more gas lines clamped between the plates. In some embodiments, the one or more ultrasonic transducers are of a piezoelectric transducer type. Alternative embodiments can implement other technology to produce vibrations into the gas line for the purpose of dislodging particles from the inner walls of the gas line. Other vibration-inducing components or energy sources capable of transmitting mechanical agitation through the plates into the gas line—such as electromagnetic actuators, mechanical oscillators, or fluidic pulsation systems—may also be employed to achieve similar particle dislodgement effects. In some embodiments, the ultrasonic transducer is configured to operate at a frequency between 20 kHz and 80 kHz. In some embodiments, surface of the first channel and the second channel comprise a material that has a first mechanical hardness less than a second mechanical hardness of the gas line, and wherein the material has acoustic transmission properties to enable ultrasonic vibration transfer into the gas line. Specifically, the materials of the first and second plates that are in contact with the gas line are selected to have a mechanical hardness less than that of the gas line, thereby preventing damage during clamping. This can include the materials of an entire plate or a coating on the plates. Suitable materials include aluminum, stainless steel, or ceramic, each possessing acoustic transmission properties that facilitate the transfer of ultrasonic vibrations from the transducers to the gas line.

FIG. 4B illustrates the ultrasonic agitation mechanism 400 from a second side schematic view, in accordance with embodiments of the present disclosure. This view similarly depicts the first plate 402 and the second plate 404, fastened together using fasteners 408A and 408B (not shown in FIG. 4B). A gas line 410A is shown positioned within the channels of both plates. Affixed to the first plate 402 and, in some embodiments, the second plate 404 are ultrasonic transducers 414A and 414B, respectively.

Unless specifically stated otherwise, terms such as “causing,” determining,” “flowing,” “receiving,” “transmitting,” “generating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms "first," "second," "third," "fourth," etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or it includes a general purpose computer system selectively programmed by a computer program stored in the computer system. In some embodiments, such a computer program is stored in a computer-readable tangible storage medium.

The methods and illustrative examples described herein are not inherently related to any particular computer or other apparatus. Various general purpose systems can be used in accordance with the teachings described herein, or a more specialized apparatus can be constructed to perform methods described herein and/or each of their individual functions, routines, subroutines, or operations. Examples of the structure for a variety of these systems are set forth in the description above.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

The terms “over,” “under,” “between,” “disposed on,” “support,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ± 10%.

Although the operations of the methods herein are shown and described in a particular order, the order of operations of each method can be altered so that certain operations are performed in an inverse order so that certain operations are performed, at least in part, concurrently with other operations. In another embodiment, instructions or sub-operations of distinct operations are in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

Some example implementations follow.

A first example implementation is a method comprising: performing a submerged ultrasonic deionized (DI) water clean on a gas line; performing a first purge operation on the gas line by flowing DI water through the gas line; performing a second purge operation on the gas line by flowing a mixture of the DI water and an inert gas through the gas line; and performing a drying operation by flowing the inert gas through the gas line.

A second example implementation may extend the first example implementation. In the second example implementation, the inert gas is nitrogen.

A third example implementation may extend any of the first through second example implementations. In the third example implementation, the method further comprises: performing a third purge operation on the gas line by flowing the DI water through the gas line prior to performing the drying operation, wherein the DI water used has a temperature less than or equal to 100°F.

A fourth example implementation may extend any of the first through third example implementations. In the fourth example implementation, an amount of DI water used for at least one of the first purge operation or the second purge operation has a temperature greater than 100°F.

A fifth example implementation may extend any of the first through fourth example implementations. In the fifth example implementation, an amount of DI water used for at least one of the first purge operation or the second purge operation has a temperature equal to or less than 100°F.

A sixth example implementation may extend any of the first through fifth example implementations. In the sixth example implementation, the inert gas has a temperature greater than 100°F.

A seventh example implementation is a gas line cleaning apparatus comprising: a first fluid line of a plurality of fluid lines, configured to provide hot DI water to a gas line; a second fluid line of the plurality of fluid lines, configured to provide cold DI water to the gas line, and wherein the second fluid line is coupled to the first fluid line and a third fluid line; and the third fluid line of the plurality of fluid lines, wherein the third fluid line is configured to provide an inert gas to the gas line, and wherein the third fluid line is coupled to the first fluid line and the second fluid line; wherein the gas cleaning apparatus is configured to: perform a first purge operation on the gas line by flowing the cold DI water through the gas line; perform a second purge operation on the gas line by flowing the hot DI water through the gas line; perform a third purge operation on the gas line by flowing a mixture of the hot DI water and the inert gas through the gas line; and perform a drying operation by flowing the inert gas through the gas line.

An eighth example implementation may extend the seventh example implementation. In the eighth example implementation, a functional fixture is a manual valve, a regulator, a transducer, a filter, a pneumatic valve, an injection valve, a check valve, a flow restrictor, a port pneumatic valve, a hybrid valve, a mass flow controller (MFC), a port block valve, a flow-through cap, a resistivity meter, a reservoir, or a fluid heater.

A ninth example implementation may extend any of the seventh through eighth example implementations. In the ninth example implementation, one or more of the plurality of fluid lines vary in diameter relative to other fluid lines of the plurality of fluid lines.

A tenth example implementation may extend any of the seventh through ninth example implementations. In the tenth example implementation, the inert gas is nitrogen.

An eleventh example implementation is a method comprising: performing a first purge operation on a gas line by flowing deionized (DI) water through the gas line while performing ultrasonic agitation on the gas line; performing a second purge operation on the gas line by flowing a mixture of the DI water and an inert gas through the gas line; and performing a drying operation by flowing the inert gas through the gas line.

A twelfth example implementation may extend the eleventh example implementation. In the twelfth example implementation, the inert gas is nitrogen.

A thirteenth example implementation may extend any of the eleventh through twelfth example implementations. In the thirteenth example implementation, the method further comprises: performing a third purge operation on the gas line by flowing the DI water through the gas line prior to performing the drying operation, wherein the DI water used has a temperature less than or equal to 100°F.

A fourteenth example implementation may extend any of the eleventh through thirteenth example implementations. In the fourteenth example implementation, an amount of DI water used for at least one of the first purge operation or the second purge operation has a temperature greater than 100°F.

A fifteenth example implementation may extend any of the eleventh through fourteenth example implementations. In the fifteenth example implementation, an amount of DI water used for at least one of the first purge operation or the second purge operation has a temperature equal to or less than 100°F.

A sixteenth example implementation may extend any of the eleventh through fifteenth example implementations. In the sixteenth example implementation, the inert gas has a temperature greater than 100°F.

A seventeenth example implementation is an ultrasonic agitation mechanism, comprising: a first plate, wherein the first plate comprises a first channel formed on an inner surface of the first plate, the first channel being configured to receive a first side of a gas line; a second plate, wherein the second plate comprises a second channel formed on an inner surface of the second plate, the second channel being configured to receive a second side of the gas line, and wherein the first plate and the second plate are affixed to each other using a mechanical fastener or compression fixture to clamp the gas line between the first plate and the second plate; and an ultrasonic transducer affixed to the first plate and configured to generate ultrasonic vibrations that are transmitted through the first plate to the gas line.

An eighteenth example implementation may extend the seventeenth example implementation. In the eighteenth example implementation, the ultrasonic agitation mechanism further comprises: a second ultrasonic transducer affixed to the second plate such that ultrasonic vibrations are transmitted through the second plate to the gas line.

A nineteenth example implementation may extend any of the seventeenth through eighteenth example implementations. In the nineteenth example implementation, a surface of the first channel and the second channel comprise a material that has a first mechanical hardness less than a second mechanical hardness of the gas line, and wherein the material has acoustic transmission properties to enable ultrasonic vibration transfer into the gas line.

A twentieth example implementation may extend any of the seventeenth through nineteenth example implementations. In the twentieth example implementation, the first plate and the second plate comprise at least one of aluminum, stainless steel, or ceramic.

A twenty-first example implementation may extend any of the seventeenth through twentieth example implementations. In the twenty-first example implementation, the ultrasonic transducer is a piezoelectric transducer.

A twenty-second example implementation may extend any of the seventeenth through twenty-first example implementations. In the twenty-second example implementation, the ultrasonic transducer is configured to operate at a frequency between 20 kHz and 80 kHz.

A twenty-third example implementation may extend any of the seventeenth through twenty-second example implementations. In the twenty-third example implementation, the first plate comprises a plurality of the first channel and the second plate comprises a plurality of the second channel, each pair of the first channel and the second channel configured to receive a separate gas line, such that multiple gas lines can be cleaned in parallel.

A twenty-fourth example implementation is a gas line cleaning apparatus comprising: a first fluid line of a plurality of fluid lines, configured to provide hot DI water to a gas line; a second fluid line of the plurality of fluid lines, configured to provide cold DI water to the gas line, wherein the second fluid line is coupled to the first fluid line; a third fluid line of the plurality of fluid lines, wherein the third fluid line is configured to provide an inert gas to the gas line, and wherein the third fluid line is coupled to the first fluid line and the second fluid line; and an ultrasonic agitation mechanism configured to be affixed to the gas line to ultrasonically agitate the gas line.

A twenty-fifth example implementation may extend the twenty-fourth example implementation. In the twenty-fifth example implementation, the gas line cleaning apparatus further comprises: a controller configured to: cause a first purge operation to be performed on the gas line that comprises flowing the cold DI water through the gas line while performing ultrasonic agitation on the gas line by the ultrasonic agitation mechanism; cause a second purge operation to be performed on the gas line that comprises flowing a mixture of the hot DI water and the inert gas through the gas line; cause a third purge operation to be performed on the gas line that comprises flowing the cold DI water through the gas line; and cause a drying operation to be performed on the gas line that comprises flowing the inert gas through the gas line.

A twenty-sixth example implementation may extend any of the twenty-fourth through twenty-fifth example implementations. In the twenty-sixth example implementation, the gas line cleaning apparatus further comprises: one or more functional fixtures coupled to at least one of the first fluid line, the second fluid line, or the third fluid line, wherein the one or more functional fixtures comprise at least one of a manual valve, a regulator, a transducer, a filter, a pneumatic valve, an injection valve, a check valve, a flow restrictor, a port pneumatic valve, a hybrid valve, a mass flow controller (MFC), a port block valve, a flow-through cap, a resistivity meter, a reservoir, or a fluid heater.

A twenty-seventh example implementation may extend any of the twenty-fourth through twenty-sixth example implementations. In the twenty-seventh example implementation, one or more of the plurality of fluid lines vary in diameter relative to other fluid lines of the plurality of fluid lines.

A twenty-eighth example implementation may extend any of the twenty-fourth through twenty-seventh example implementations. In the twenty-eighth example implementation, the ultrasonic agitation mechanism comprises: a first plate, wherein the first plate comprises a first channel formed on an inner surface of the first plate, the first channel being configured to receive a first side of a gas line; a second plate, wherein the second plate comprises a second channel formed on an inner surface of the second plate, the second channel being configured to receive a second side of the gas line, and wherein the first plate and the second plate are affixed to each other using a mechanical fastener or compression fixture to clamp the gas line between the first plate and the second plate; an ultrasonic transducer affixed to the first plate and configured to generate ultrasonic vibrations that are transmitted through the first plate to the gas line; and wherein a surface of the first channel and the second channel comprise a material that has a first mechanical hardness less than a second mechanical hardness of the gas line, and wherein the material has acoustic transmission properties to enable ultrasonic vibration transfer into the gas line.

What is claimed is:

1. A gas line cleaning apparatus comprising:
a first fluid line of a plurality of fluid lines, configured to provide hot DI water to a gas line;
a second fluid line of the plurality of fluid lines, configured to provide cold DI water to the gas line, and wherein the second fluid line is coupled to the first fluid line and a third fluid line; and
the third fluid line of the plurality of fluid lines, wherein the third fluid line is configured to provide an inert gas to the gas line, and wherein the third fluid line is coupled to the first fluid line and the second fluid line;
wherein the gas line cleaning apparatus is configured to:
perform a first purge operation on the gas line by flowing the cold DI water through the gas line;
perform a second purge operation on the gas line by flowing the hot DI water through the gas line;
perform a third purge operation on the gas line by flowing a mixture of the hot DI water and the inert gas through the gas line; and
perform a drying operation by flowing the inert gas through the gas line.

2. The gas line cleaning apparatus of claim 1, wherein a functional fixture is a manual valve, a regulator, a transducer, a filter, a pneumatic valve, an injection valve, a check valve, a flow restrictor, a port pneumatic valve, a hybrid valve, a mass flow controller (MFC), a port block valve, a flow-through cap, a resistivity meter, a reservoir, or a fluid heater.

3. The gas line cleaning apparatus of claim 1, wherein one or more of the plurality of fluid lines vary in diameter relative to other fluid lines of the plurality of fluid lines.

4. The gas line cleaning apparatus of claim 1, wherein the inert gas is nitrogen.

5. A gas line cleaning method comprising:
performing a first purge operation on a gas line by flowing deionized (DI) water through the gas line while performing ultrasonic agitation on the gas line;
performing a second purge operation on the gas line by flowing a mixture of the DI water and an inert gas through the gas line; and
performing a drying operation by flowing the inert gas through the gas line.

6. The gas line cleaning method of claim 5, wherein the inert gas is nitrogen.

7. The gas line cleaning method of claim 5, the method further comprising:
performing a third purge operation on the gas line by flowing the DI water through the gas line prior to performing the drying operation, wherein the DI water used has a temperature less than or equal to 100°F.

8. The gas line cleaning method of claim 5, wherein an amount of DI water used for at least one of the first purge operation or the second purge operation has a temperature greater than 100°F.

9. The gas line cleaning method of claim 5, wherein an amount of DI water used for at least one of the first purge operation or the second purge operation has a temperature equal to or less than 100°F.

10. The gas line cleaning method of claim 5, wherein the inert gas has a temperature greater than 100°F.

11. The gas line cleaning method of claim 5, further comprising:
performing a submerged ultrasonic deionized (DI) water clean on the gas line.

12. A gas line cleaning apparatus comprising:
a first fluid line of a plurality of fluid lines, configured to provide hot DI water to a gas line;
a second fluid line of the plurality of fluid lines, configured to provide cold DI water to the gas line, wherein the second fluid line is coupled to the first fluid line;
a third fluid line of the plurality of fluid lines, wherein the third fluid line is configured to provide an inert gas to the gas line, and wherein the third fluid line is coupled to the first fluid line and the second fluid line; and
an ultrasonic agitation mechanism configured to be affixed to the gas line to ultrasonically agitate the gas line.

13. The gas line cleaning apparatus of claim 12, further comprising:
a controller configured to:
cause a first purge operation to be performed on the gas line that comprises flowing the cold DI water through the gas line while performing ultrasonic agitation on the gas line by the ultrasonic agitation mechanism;
cause a second purge operation to be performed on the gas line that comprises flowing a mixture of the hot DI water and the inert gas through the gas line;
cause a third purge operation to be performed on the gas line that comprises flowing the cold DI water through the gas line; and
cause a drying operation to be performed on the gas line that comprises flowing the inert gas through the gas line.

14. The gas line cleaning apparatus of claim 12, further comprising:
one or more functional fixtures coupled to at least one of the first fluid line, the second fluid line, or the third fluid line, wherein the one or more functional fixtures comprise at least one of a manual valve, a regulator, a transducer, a filter, a pneumatic valve, an injection valve, a check valve, a flow restrictor, a port pneumatic valve, a hybrid valve, a mass flow controller (MFC), a port block valve, a flow-through cap, a resistivity meter, a reservoir, or a fluid heater.

15. The gas line cleaning apparatus of claim 12, wherein one or more of the plurality of fluid lines vary in diameter relative to other fluid lines of the plurality of fluid lines.

16. The gas line cleaning apparatus of claim 12, wherein the ultrasonic agitation mechanism comprises:
a first plate, wherein the first plate comprises a first channel formed on an inner surface of the first plate, the first channel being configured to receive a first side of a gas line;
a second plate, wherein the second plate comprises a second channel formed on an inner surface of the second plate, the second channel being configured to receive a second side of the gas line, and wherein the first plate and the second plate are affixed to each other using a mechanical fastener or compression fixture to clamp the gas line between the first plate and the second plate;
an ultrasonic transducer affixed to the first plate and configured to generate ultrasonic vibrations that are transmitted through the first plate to the gas line.

17. The gas line cleaning apparatus of claim 16, wherein a surface of the first channel and the second channel comprise a material that has a first mechanical hardness less than a second mechanical hardness of the gas line.

18. The gas line cleaning apparatus of claim 17, wherein the material has acoustic transmission properties to enable ultrasonic vibration transfer into the gas line.

19. The gas line cleaning apparatus of claim 16, wherein the ultrasonic agitation mechanism further comprises a second ultrasonic transducer affixed to the second plate such that ultrasonic vibrations are transmitted through the second plate to the gas line.

20. The gas line cleaning apparatus of claim 16, wherein:
first plate and the second plate comprise at least one of aluminum, stainless steel, or ceramic;
the ultrasonic transducer is a piezoelectric transducer configured to operate at a frequency between 20 kHz and 80 kHz.
